(19) United States
(12) Patent Application Publication
(10) Pub. No.: US 2015/0331286 A1
(43) Pub. Date: Nov. 19, 2015

(54) METHOD FOR COATING LIQUID CRYSTAL AND METHOD FOR MANUFACTURING A DISPLAY PANEL

(71) Applicants: Boe Technology Group Co., Ltd., Beijing (CN); Beijing Boe Display Technology Co., Ltd., Beijing (CN)

(72) Inventor: Wei Yan, Beijing (CN)

(21) Appl. No.: 14/499,555

(22) Filed: Sep. 29, 2014

(30) Foreign Application Priority Data
May 16, 2014 (CN) 201410208797.4

(51) Int. Cl. G02F 1/1337

(52) U.S. Cl. CPC G02F 1/133788; G02F 1/133723

(57) ABSTRACT

Embodiments of the present invention disclose a method for coating liquid crystal and a method for manufacturing a display panel, and relate to the field of display, being able of achieving an orientational arrangement of liquid crystal molecules while coating the liquid crystal, thereby avoiding badness caused by rubbing the orientation film and dropping the liquid crystal. The method for coating liquid crystal comprises: forming an orientation film on a light-transmissive substrate, wherein orientation film molecules in the orientation film are orientationally arranged; using a slit nozzle to coat a liquid crystal material on the light-transmissive substrate, on which the orientation film is formed, wherein the liquid crystal material comprises liquid crystal molecules and photosensitive reaction groups; and using a first UV light to irradiate the liquid crystal material while coating the liquid crystal material.

### RELATED APPLICATIONS

The present application claims the benefit of Chinese Patent Application No. 201410208797.4, filed May 16, 2014, the entire disclosure of which is incorporated herein by reference.

### FIELD OF THE INVENTION

The present invention relates to the field of display technique, in particular to a method for coating liquid crystal.

### BACKGROUND OF THE INVENTION

A display panel mainly comprises an array substrate, a color film substrate and a liquid crystal layer formed between the array substrate and the color film substrate. In order to enable the display panel having a uniform brightness and a high contrast, liquid crystal molecules in the liquid crystal molecule layer are typically arranged along a certain direction.

At present, the orientational arrangement of the liquid crystal molecules is achieved mainly through the following procedure: firstly, forming a layer of orientation film on an array substrate; then, rubbing the orientation film so as to form a plurality of parallel grooves on the surface of the orientation film; finally, dropping liquid crystal onto the array substrate, such that the liquid crystal molecules are orientationally arranged along the grooves on the orientation film.

The inventors found that a variety of badnesses are easy to occur during the process of rubbing the orientation film and dropping the liquid crystal, for example, fine particles appear on the surface of the orientation film during the rubbing process, and burrs appear on the grooves formed by rubbing, etc.; the perimeter areas of the display panel can't be filled with the liquid crystal molecules during the dropping process, and liquid crystal contamination caused by premature contact between the liquid crystal molecules and frame sealing glue, etc. These badnesses will have bad effects on the display effect of the display panel.

### SUMMARY OF THE INVENTION

A technical problem to be solved by the invention is to provide a method for coating liquid crystal and a method for manufacturing a display panel being able of achieving an orientational arrangement of the liquid crystal material molecules while coating the liquid crystal, thereby avoiding the badness caused by rubbing the orientation film and dropping the liquid crystal.

In order to solve the above technical problem, the embodiments of the present invention provide a method for coating liquid crystal with the following technical solution:

a method for coating liquid crystal comprises:

forming an orientation film on a light-transmissive substrate, wherein orientation film molecules in the orientation film are orientationally arranged;

using a slit nozzle to coat a liquid crystal material on the light-transmissive substrate, on which the orientation film is formed, the liquid crystal material comprises liquid crystal molecules and photosensitive reaction groups; and

using a first UV light to irradiate the liquid crystal material while coating the liquid crystal material.

The step of forming an orientation film on a light-transmissive substrate, wherein orientation film molecules in the orientation film are orientationally arranged, comprises:

forming a layer of orientation film material solution on the light-transmissive substrate;

performing a curing treatment for the orientation film material solution to form the orientation film;

using a second UV light to irradiate the orientation film, such that the orientation film molecules in the orientation film are orientationally arranged.

The orientation film material can be polyimide, and the orientation film can be a polyimide film.

The curing treatment comprises a pre-curing treatment and a main curing treatment.

The temperature range of the pre-curing treatment is 125 to 135 degrees centigrade, the duration for the pre-curing treatment is 130 seconds, the temperature range of the main curing treatment is 225 to 235 degrees centigrade, and the duration for the main curing treatment is 1200 seconds.

The second UV light is a polarized light with a wavelength of 313 nm and a light intensity of 300-40 mJ/cm².

The photosensitive reaction groups are groups containing carbon-carbon double bonds.

The step of using a first UV light to irradiate the liquid crystal material while coating the liquid crystal material comprises:

the slit nozzle and the first UV light are located respectively at two sides of the light-transmissive substrate; the first UV light and the slit nozzle advance synchronously.

The wavelength of the first UV light is 365 nm, and the light intensity of the first UV light is 7.5 mJ/cm².

The method for coating liquid crystal comprises: forming an orientation film on a light-transmissive substrate, wherein orientation film molecules in the orientation film are orientationally arranged; then, using a slit nozzle to coat a liquid crystal material on the light-transmissive substrate, on which the orientation film is formed, the liquid crystal material comprises liquid crystal molecules and photosensitive reaction groups; additionally, using a first UV light to irradiate the liquid crystal material while coating the liquid crystal material. Because of the orientational arrangement of the orientation film molecules in the orientation film, when the liquid crystal material is irradiated with the UV light, due to presence of intermolecular forces between the photosensitive reaction groups in the liquid crystal material and the orientation film molecules, the photosensitive reaction groups are arranged along the same direction as the orientation film molecules; similarly, there are also intermolecular forces between the liquid crystal molecules and the photosensitive reaction groups, therefore the liquid crystal molecules are aligned in the same direction, achieving the orientational arrangement of the liquid crystal molecules while coating the liquid crystal material, thereby avoiding badness caused by rubbing the orientation film and dropping the liquid crystal.

In addition, the embodiments of the present invention also provide a method for manufacturing a display panel, and the method for manufacturing a display panel comprises the method for coating liquid crystal as set forth in any of the above embodiments.

The manufacturing method achieves the orientational arrangement of the liquid crystal molecules while coating the liquid crystal material, avoiding rubbing the orientation film and dropping the liquid crystal, thereby avoiding badness that may occur during the rubbing process and the dropping process, such that the display panel has a better display effect.

### BRIEF DESCRIPTION OF THE DRAWINGS

In order to illustrate the embodiments of the present invention or the technical solutions in the prior art more clearly, figures used in the description of the embodiments will be introduced briefly. The figures in the following description are only some embodiments of the present invention. For one of ordinary skill in the art, other figures can be obtained based on these figures without creative efforts.

FIG. 1 is a flow diagram of a method for coating liquid crystal in an embodiment of the present invention;

FIG. 2 is a schematic view of a liquid crystal coating process in an embodiment of the present invention; and

FIG. 3 is a specific flow diagram of the step S101 in FIG. 1.

### DETAILED DESCRIPTION OF THE INVENTION

Technical solutions in the embodiments of the present invention will be described clearly and completely below, by referring to the drawings of the embodiments of the present invention. Obviously, the described embodiments are part of the embodiments of the present invention, not all the embodiments of the present invention. Based on the embodiments of the present invention, all other embodiments obtained by one of ordinary skill in the art without creative efforts belong to the protection scope of the present invention.

Embodiments of the present invention provide a method for coating liquid crystal being able of achieving an orientational arrangement of the liquid crystal material molecules while coating the liquid crystal, thereby avoiding badness caused by rubbing the orientation film and dropping the liquid crystal.

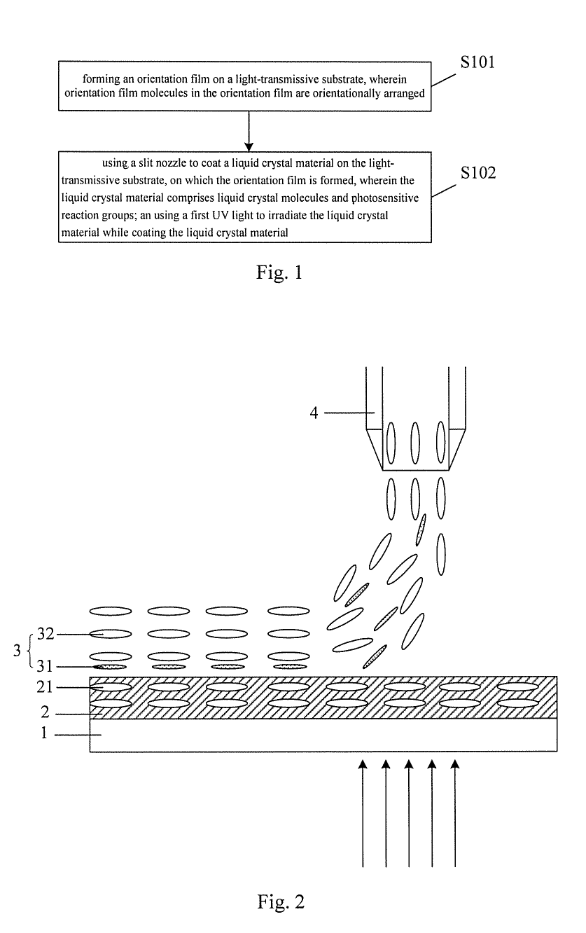

Specifically, as shown in FIG. 1, a method for coating liquid crystal comprises:

Step S101: forming an orientation film on a light-transmissive substrate, wherein orientation film molecules in the orientation film are orientationally arranged; and

Step S102: using a slit nozzle to coat a liquid crystal material on the light-transmissive substrate, on which the orientation film is formed, wherein the liquid crystal material comprises liquid crystal molecules and photosensitive reaction groups; and using a first UV light to irradiate the liquid crystal material while coating the liquid crystal material.

As shown in FIG. 2, after using the above coating method to coat the liquid crystal material 3 onto the light-transmitting substrate 1, there are acting forces such as Van der Waals' force, attractive forces between the dipoles and hydrogen bonds etc. between the orientationally arranged orientation film molecules 21 in the orientation film 2 and the photosensitive reaction groups in the liquid crystal material 3, these acting forces become the main acting forces for the orientational arrangement of the photosensitive reaction groups 31, therefore, the photosensitive reaction groups 31 orientationally arranged along the same direction as the orientation film molecules 21; moreover, since the above several acting forces are also present between the photosensitive reaction groups 31 and the liquid crystal molecules 32, the liquid crystal molecules 32 can be orientationally arranged along the same direction. Rubbing on the surface of the orientation film 2 is not required during the entire process, thus avoiding badnesses such as the presence of fine particles on the surface of the orientation film 2 and burrs on the surface of the orientation film 2, etc., which in turn makes the orientation of the liquid crystal molecules 32 better and had a smaller pre-tilt angle, thus light scattering by the liquid crystal molecules 32 can be reduced and the display effect of the display panel can be improved.

From the above discussion, during the process of achieving the orientational arrangement of the liquid crystal molecules 32, the photosensitive reaction groups 31 play an essential role. Since the carbon-carbon double bonds are prone to react with each other to generate free radicals under the irradiation of the first UV light, strong interaction appears between the photosensitive reaction groups 31 and the orientation film molecules 21, which achieves the orientational arrangement of the photosensitive reaction groups 31 and the orientational arrangement of the liquid crystal molecules 32 in turn; therefore, the photosensitive reaction groups 31 in the embodiments of the present invention preferably are groups containing carbon-carbon double bonds.

Additionally, in the embodiments of the present invention, the slot nozzle 4 is used to coat the liquid crystal material 3 on the light-transmissive substrate 1, compared to the method of dropping the liquid crystal, the liquid crystal material 3 can be distributed more evenly over the entire light-transmissive substrate 1. Meanwhile, the liquid crystal molecules 32 can be orientationally arranged more quickly, with a small liquidity. Accordingly, when the method for coating liquid crystal in the embodiments of the present invention is applied into manufacturing of display panel, the premature contact between the liquid crystal molecules 32 and the frame sealing glue can be effectively avoided, thereby avoiding contamination of the liquid crystal molecules 32.

The method for coating liquid crystal provided by the embodiments of the present invention comprises: forming an orientation film on a light-transmissive substrate, wherein orientation film molecules in the orientation film are orientationally arranged; then, using a slit nozzle to coat a liquid crystal material on the light-transmissive substrate, on which the orientation film is formed, wherein the liquid crystal material comprises liquid crystal molecules and photosensitive reaction groups; additionally, using a first UV light to irradiate the liquid crystal material while coating the liquid crystal material. Because of the orientational arrangement of the orientation film molecules in the orientation film, when the liquid crystal material is irradiated with UV light, due to presence of intermolecular force between the photosensitive reaction groups in the liquid crystal material and the orientation film molecules, the photosensitive reaction groups are arranged along the same direction as the orientation film molecules; similarly, there are also the intermolecular force between the liquid crystal molecules and the photosensitive reaction groups, such that the liquid crystal molecules are aligned in the same direction, achieving the orientational arrangement of the liquid crystal molecules while coating the liquid crystal material, thereby avoiding badness caused by rubbing the orientation film and dropping the liquid crystal.

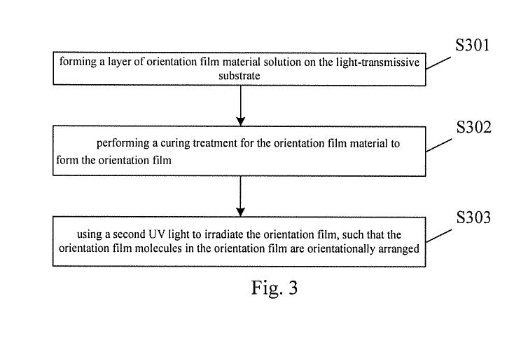

Further, the step S101, in which an orientation film is formed on the light-transmissive substrate, with the molecules in the orientation film orientationally arranged, comprises the steps as shown in FIG. 3:

Step S301: forming a layer of orientation film material solution on the light-transmissive substrate.

From the above it can be seen that, the intention of forming the orientation film 2 in the embodiments of the present intention is that, there are acting forces such as Van der Waals' force, attractive forces between the dipoles and hydrogen bonds etc. between the orientationally arranged orientation film molecules 21 in the orientation film 2 and the photosensitive reaction groups 31 in the liquid crystal material 3. These acting forces make that the photosensitive reaction groups 31 orientationally arranged along the same direction as the orientation film molecules 21, in turn, since the above several acting forces are also present between the photosensitive reaction groups 31 and the liquid crystal molecules 32, therefore, the liquid crystal molecules 32 can be orientationally arranged along the same direction.

Therefore, the orientation film material for forming the orientation film 2 should meet the following requirements: 1) has good orientation effect for the liquid crystal alignment material 3; 2) has good machining property, and is easy to adopt spin coating, roll coating, dip coating, ink-jet, etc. to form an uniform film on the surface of the light-transmissive substrate 1; 3) produces no chemical reaction with the liquid crystal molecule 32; 4) has large adhesive force with the light-transmissive substrate 1; 5) has hydrophobicity, etc. Since the polyimide can meet the above requirements well, the orientation film material in the embodiments of the present invention is preferably polyimide, e.g., SE-6414 polyimide solution. An ink-jet process can be adopted to spray the above solution on the light-transmissive substrate 1, thereby forming a layer of orientation film material solution on the light-transmissive substrate 1.

Step S302: performing curing treatment for the orientation film material solution to form an orientation film.

If the polyimide orientation film material is polyimide, the formed orientation film 2 is a polyimide film. In order to form a polyimide film, the curing treatment of the orientation film material solution comprises two steps: a pre-curing treatment and a curing treatment. Wherein the temperature range of the pre-curing treatment is 125 to 135 degrees centigrade, the duration for the pre-curing treatment is 130 seconds, and the function of the pre-curing treatment is to remove the water in the solvent of the orientation film material solution; the temperature range of the main pre-curing treatment is 225 to 235 degrees centigrade, the duration for the main pre-curing treatment is 1200 seconds, and the function of the main pre-curing treatment is to generate cross-linking reaction between the polyimide molecules, then the polyimide molecules are cured, forming a polyimide film.

Step S303: using a second UV light to irradiate the orientation film, such that the orientation film molecules in the orientation film are orientationally arranged.

Since the function of using the second UV light to irradiate the orientation film 2 is to make the orientation film molecules 21 orientationally arranged, the second UV light should be polarized light. Further, in order to make the orientation film molecules 21 have a good orientation under the irradiation of the second UV light, while structure of the orientation film molecules 21 themselves are not damaged, preferably, the second UV light in the present invention is polarized light with a wavelength of 313 nm and a light intensity of 30-40 mJ/cm². In addition, it should be clarified that, the method of forming the orientation film 2 provided by the present invention can comprise the steps S301-S303, but is not limited thereto, and any methods being able of forming an orientation film with orientational arrangement of the orientation film molecules 21 can be used, the present invention is not limited to this.

Further, as described above, it can be seen that, in order to achieve an orientational arrangement of the liquid crystal molecules 32 while coating the liquid crystal material 3, the method for coating liquid crystal in the embodiments of the present invention needs to use the first UV light to irradiate the liquid crystal material 3 while coating the liquid crystal material 3. For rational use of the energy of the first UV and cost saving, as shown in FIG. 2, it is preferable that, in the embodiments of the present invention, the slit nozzle 4 and the first UV light are located respectively on two sides of the light-transmissive substrate 1; the first UV light (indicated by arrows) and the slit nozzle 4 advance synchronously. Optionally, the wavelength of the first UV light is 365 nm, and the light intensity of the first UV light is 7.5 mJ/cm².

In addition, the embodiments of the present invention also provide a method for manufacturing a display panel, the method for manufacturing a display panel comprises the method for coating liquid crystal as set forth in any of the above embodiments.

Specifically, the method for manufacturing a display panel comprises manufacture of an array substrate, manufacture of a color film substrate, coating liquid crystal material on the array substrate, while coating frame sealing glue on the edges of the color film substrate, performing box alignment between the array substrate and the color film substrate in a vacuum, curing the frame sealing glue and other steps. Wherein the frame sealing glue can be a light curable type or a thermal curable type. When selecting a light curable type frame sealing glue, optionally, a UV light with a wavelength of 330 nm to 400 nm and a intensity of 3000 mJ/cm² can be used to irradiate the frame sealing glue to make it cured; when selecting a thermal curable type frame sealing gum, optionally, the frame sealing glue can be cured by keeping it under 120 degrees centigrade for 60 minutes.

Embodiments of the present invention provide a method for manufacturing a display panel. The manufacturing method achieves the orientational arrangement of the liquid crystal molecules while coating the liquid crystal material, avoiding rubbing the orientation film and dropping the liquid crystal, thereby avoiding badness that may occur during the rubbing process and the dropping process, such that the display panel has a better display effect.

The above mentioned are only embodiments of the present invention, and the protection scope of the present invention is not limited thereto. Any variations or replacements, which can be easily thought by those skilled in the art based on the technical scope disclosed by the present invention, should be covered within the protection scope of the present invention. Accordingly, the protection scope of the invention should be the scope of the claims.

What is claimed is:

1. A method for coating liquid crystal, comprising:
forming an orientation film on a light-transmissive substrate, wherein orientation film molecules in the orientation film are orientationally arranged;
using a slit nozzle to coat a liquid crystal material on the light-transmissive substrate on which the orientation film is formed, wherein the liquid crystal material comprises liquid crystal molecules and photosensitive reaction groups; and
using a first UV light to irradiate the liquid crystal material while coating the liquid crystal material.

2. The method for coating liquid crystal according to claim 1, wherein forming an orientation film on the light-transmissive substrate, in which orientation film molecules in the orientation film are orientationally arranged, comprises:
forming a layer of orientation film material solution on the light-transmissive substrate;
performing a curing treatment for the orientation film material to form the orientation film;
using a second UV light to irradiate the orientation film, such that the orientation film molecules in the orientation film are orientationally arranged.

3. The method for coating liquid crystal according to claim 2, wherein the orientation film material is polyimide, and the orientation film is a polyimide film.

4. The method for coating liquid crystal according to claim 3, wherein the curing treatment further comprises a pre-curing treatment and a main curing treatment, each having a temperature range.

5. The method for coating liquid crystal according to claim 4, wherein the temperature range of the pre-curing treatment is 125 to 135 degrees centigrade, the duration for the pre-curing treatment is 130 seconds, the temperature range of the main curing treatment is 225 to 235 degrees centigrade, and the duration for the main curing treatment is 1200 seconds.

6. The method for coating liquid crystal according to claim 2, wherein the second UV light is a polarized light with a wavelength of 313 nm and a light intensity of 30-40 mJ/cm².

7. The method for coating liquid crystal according to claim 1, wherein the photosensitive reaction groups are groups containing carbon-carbon double bonds.

8. The method for coating liquid crystal according to claim 1, wherein using the first UV light to irradiate the liquid crystal material while coating the liquid crystal material comprises:
a slit nozzle and a first UV light that are located respectively at two sides of the light-transmissive substrate; and the first UV light and the slit nozzle advance synchronously.

9. The method for coating liquid crystal according to claim 8, wherein the wavelength of the first UV light is 365 nm and the light intensity of the first UV light is 7.5 mJ/cm².

10. A method for manufacturing a display panel, comprising the method for coating liquid crystal according to claim 1.
